(19) United States
(12) Patent Application Publication
(10) Pub. No.: US 2006/0150037 A1
(43) Pub. Date: Jul. 6, 2006

(54) Methods and systems for operating system recovery

(75) Inventor: Huai Cheng Wang, Taoyuan County (TW)

Correspondence Address: QUINTERO LAW OFFICE, 1617 BROADWAY, 3RD FLOOR, SANTA MONICA, CA, 90404, US

(73) Assignee: MITAC TECHNOLOGY CORP., HSIN-CHU HSIEN (TW)

(21) Appl. No.: 11/091,842

(22) Filed: Mar. 28, 2005

(30) Foreign Application Priority Data
Dec. 30, 2004 (TW) TW93141339

(51) Int. Cl. G06F 11/00

(52) U.S. Cl. 714/100

(57) ABSTRACT

A method and system for operating system recovery. A flag and setting up a quick key is defined to the computer system. The computer system provides a hard disk comprising at least one first disk partition and second disk partition. The first disk partition comprises an operating system and the second disk partition comprises a recovery program and an image file corresponding to source installation programs of the operating system. The quick key is triggered to activate the operating system and a corresponding flag value is set accordingly. The recovery program is loaded into a storage medium of the computer system according to the flag value and executed to create a recovery system. The recovery system executes operating system installation using the image file recover the operating system of the computer system.

### BACKGROUND

The invention relates to computer systems, and more particularly, to methods for operating system (OS) recovery that returns the OS to a default installation state.

┌System recovery processes┘ can restore an operating system of a computer to a previously normal operating state. An operating system such as Windows continuously monitors and records changes in kernel files and system registration files. Accordingly, when the operating system becomes unstable due to being hacked or abnormal operation, a system recovery operation can be executed to restore the operating system.

Additionally, the recovery operation can also be implemented using a ┌Recovery CD(Compact Disk)┘. To implement the system recovery operation, data must first be backed up. An operating system is decompressed and backed up as an image file or executable file, and the image or executable file is burned in a compact disk. The details of system recovery process methods are described in the following.

The ┌Recovery CD┘ is loaded in a CD-ROM drive the operating system executes. The operating system automatically accesses and executes a recovery program in the ┌Recovery CD┘, such that a user is only required to enable a system recovery function shown in a function menu to activate a system recovery procedure. The procedure reads out the image file from the ┌Recovery CD┘ and over-writes a disk partition where the corrupt operating system is stored.

In another method, the computer system is booted by the CD-ROM. The ┌Recovery CD┘ is loaded in the CD-ROM drive, and a power button is pressed to boot the computer system, thus the image file from the ┌Recovery CD┘ is automatically read out, over-writing a disk partition where the operating system is located.

The system recovery process implemented with more than the two described methods but use of the ┌Recovery CD┘ is the most commonly used. Success of the recovery process using a recovery program depends on whether the backup image file is damaged and the currently used backup program is the same as the backup program originally used to back of the image file. Additionally, a backup image file corresponding to a disk partition can only be recovered to an operating system of the disk partition. An image file, for example, corresponding to a first partition is only recovered to an operating system on the first disk partition.

Thus, a more convenient recovery method is desirable.

### SUMMARY

Systems for operating system recovery applied to a computer system are provided. An embodiment of such a system comprises a storage medium, a hard disk, a recovery key, and a BIOS. The hard disk comprises at least one first disk partition and one second disk partition. The first disk partition comprises an operating system and the second disk partition comprises a recovery program and an image file corresponding to source installation programs of the operating system. The quick key is set up corresponding to the computer system. The BIOS loads the recovery program into the storage medium system according to a flag when the recovery key is triggered, executes the recovery program for creating a recovery system, and executes operating system installation using the image file based on the recovery system to recover the operating system of the computer system.

Also disclosed are methods for operating system recovery applied to a computer system. In an embodiment of such a method, a flag and a quick key are defined on the computer system. The computer system provides a hard disk comprising at least one first disk partition and one second disk partition. The first disk partition comprises an operating system and the second disk partition comprises a recovery program and an image file corresponding to source installation programs of the operating system. The quick key is triggered to activate the operating system and a corresponding flag value is set accordingly. The recovery program is loaded into a storage medium of the computer system according to the flag value and executed to create a recovery system. The recovery system executes operating system installation using the image file to recover the operating system of the computer.

### BRIEF DESCRIPTION OF THE DRAWINGS

The present invention can be more fully understood by reading the subsequent detailed description and examples of embodiments thereof with reference made to the accompanying drawings, wherein:

FIG. 1 is a schematic view of an embodiment of a system for operating system recovery; and

FIG. 2 is flowchart of an embodiment of a method for operating system recovery.

### DETAILED DESCRIPTION

Embodiments of the invention disclose a method and system for operating system recovery.

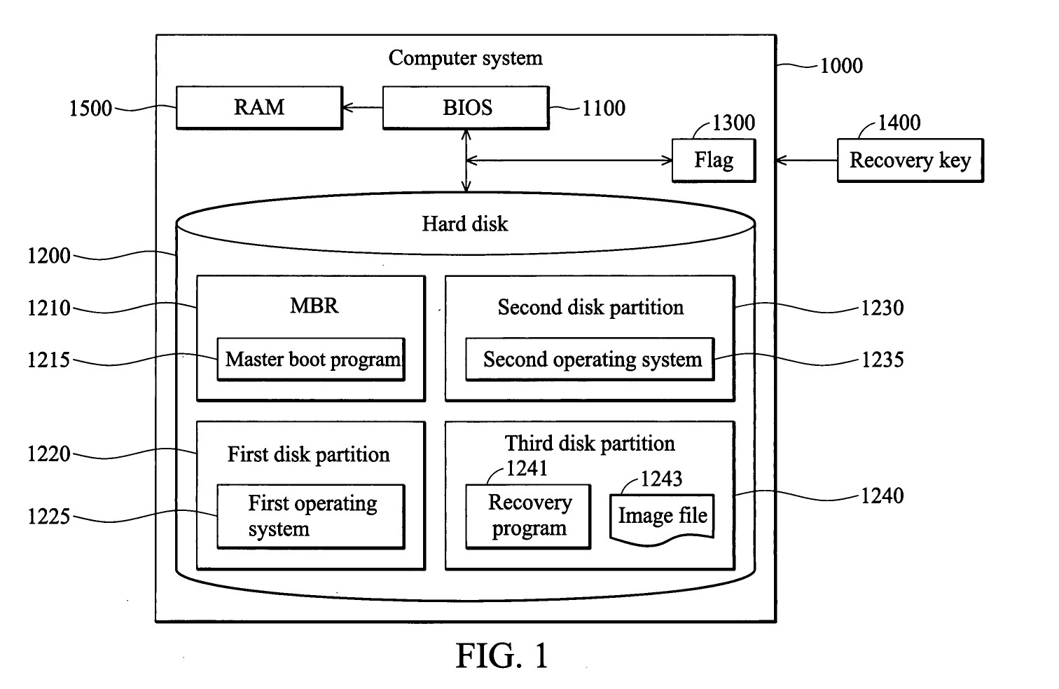

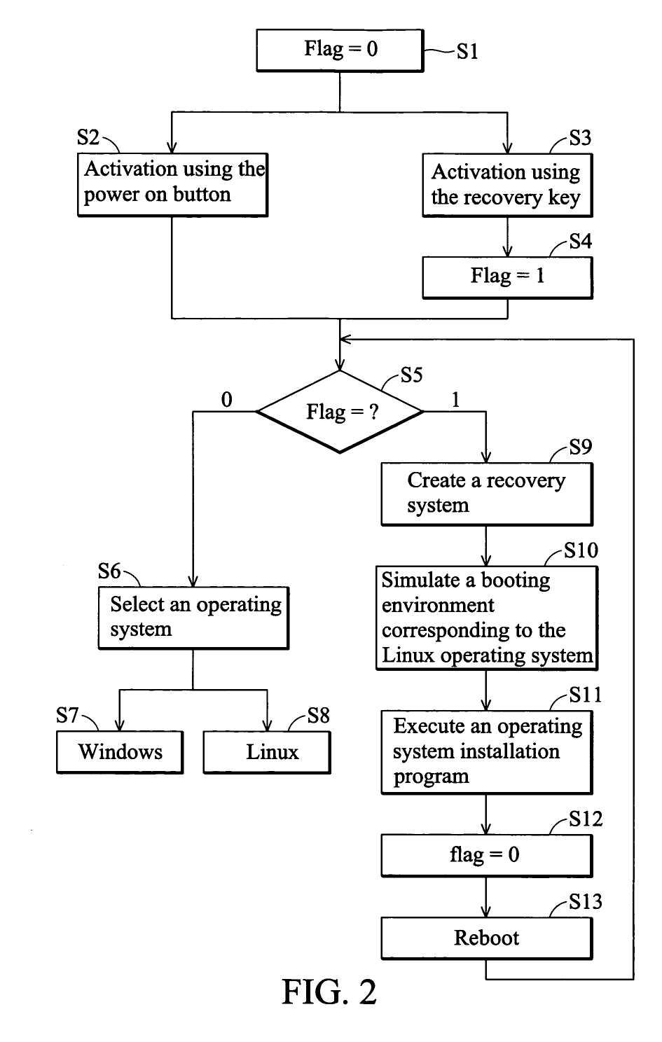

Several exemplary embodiments of the invention are described with reference to FIGS. 1 through 2, which generally relate to operating system recovery. While some embodiments of the invention operate with the system recovery processes, it is understood that the system patterned by the recovery processes is not critical, and other processing processes patterning an operating system according to a recovery function may be readily substituted.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the Figures corresponds to the Figure number, with the exception that the same reference number is used throughout to refer to an identical component which appears in multiple Figures.

FIG. 1 is a schematic view of an embodiment of a system for operating system recovery.

An embodiment of the system for operating system recovery is applied to a computer system 1000, comprising a basic input/output system (BIOS) 1100, a hard disk 1200, a flag 1300, a recovery key 1400, and a random access memory (RAM) 1500.

BIOS 1100 is the firmware of a motherboard of computer 1000, stored in a read only memory (ROM) of the motherboard and providing basic input/output operations, system setting, and hardware test functions.

Hard disk 1200 comprises a master boot record (MBR) 1210, a first disk partition 1220, a second disk partition 1230, and a third disk partition 1240. MBR 1210 is saved in the cylinder 0, head 0, and sector 1 of hard disk 1200, comprising a master boot program 1215 and a master partition table (not shown). All operations to access data in hard disk 1200 are implemented according to states and end addresses of the master partition table. Additionally, when computer system 1000 is powered on, master boot program 1215 retrieves a bootable sector in a bootable partition.

First disk partition 1220 is a bootable partition of computer system 1000 in this embodiment, in which a first operating system 1225 is discovered. First operating system 1225 is generally a Windows operating system. Second disk partition 1230 is another disk partition of computer system 1000, comprising a second operating system (such as a Linux operating system) 1235 in this embodiment of the invention. Third disk partition 1240 is further another disk partition of computer system 1000, comprising at least one recovery program 1241 and an image file 1243 corresponding to source installation programs of an operating system with respect to recovery program 1241. Recovery program 124 decompresses image file 1243 and executes an operating system installation process, recovering first operating system 1225 of first disk partition 1220 or second operating system 1235 of second disk partition 1230.

Flag 1300 is defined using simulation software in this embodiment of the invention, but is not thus intended to limit the invention. Flag 1300 can also be set up with hardware, such as a register. A boot mode determined using flag 1300 after computer system 1000 is activated. Recovery key 1400 can be set up for computer system 1000 using a general purpose input/output (GPIO) circuit, but is not intended to limit the invention. BIOS 1100 of computer system 1000 determines a boot mode according to flag 1300. A recovery process implemented by the system of an embodiment of the invention is described in the following.

Recovery key 1400 is depressed to activate computer system 1000, thus generating a signal value corresponding to recovery 1400. The value of flag 1300 is subtracted by one according to the signal value. Computer system 1000, for example, is normally activated when the flag value is 0, and, a system recovery operation is executed when the flag value is 1. In this embodiment of the invention, the flag value generated based on the signal value is predetermined as 1, such that BIOS 1100 immediately executes a system recovery operation upon obtaining the flag value. Second operating system (such as a Linux operating system) 1235 of second disk partition 1230 is predetermined for recovery when the system recovery operation is executed in this embodiment of the invention. If an operating system of another disk partition requires recovery, one more recovery keys can be set or a recovery menu can be created using a software simulation and the desired operating system is then manually selected.

Next, BIOS 1110 of computer system 1000 loads recovery program 1241 in third disk partition 1240 according to the flag value 1300 for execution (under the disk operating system (DOS) environment), thus creating a recovery system (not shown). The recovery system is then executed to simulate a boot environment corresponding to the Linux operating system. Next, the recovery system decompresses image file 1243 in third disk partition 1240 and executes an operating system installation program. After the operating system is completely installed, flag value 1300 is set as 0, and computer system 1000 is then rebooted. After computer system 1000 is rebooted, BIOS 1100 detects that flag value 1300 is 0 and executes a normal boot procedure accordingly. Master boot program 1215 of master boot record 1210 selectively activates the first operating system (such as a Windows operating system) 1225 in the first disk partition 1220 or the second operating system (such as a Linux operating system)) 1235 in the second disk partition 1230.

FIG. 2 is flowchart of an embodiment of a method for operating system recovery.

A flag is first defined and the value thereof is set as 0 (step S1). A computer system is activated using a power button or quick key (steps S2 and S3). A hard disk of the computer system comprises a first disk partition, a second disk partition, and a third disk partition. The first disk partition comprises a first operating system (such as a Windows operating system), the second disk partition comprises a second operating system (such as a Linux operating system), and the third disk partition comprises at least one recovery program and an image file corresponding to source installation programs of an operating system with respect to recovery program.

A signal value corresponding to the quick key is generated when the quick key is depressed to activate the computer system, and the flag value is set as 1 according to the signal value (step S4). Next, it is determined whether to normally start a boot procedure or execute a system recovery operation (step S5). The computer system, for example, is normally activated when the flag value is 0, and, a system recovery operation is executed when the flag value is 1. The process proceeds to step S6 when the computer system is activated by the power button, or, to step S9, by the quick key.

The computer system is normally activated and it is determined whether the first operating system (such as a Windows operating system) or the second operating system (such as a Linux operating system) is activated using a boot menu, a hot key, or a function key (step S6˜S8) The recovery program in the third disk partition is loaded into a random access memory for execution when the system recovery operation is executed, thus creating a recovery system (step S9). Next, the recovery system is executed to simulate a boot environment corresponding to the Linux operating system (step S10). The second operating system (such as a Linux operating system) of the second disk partition is predetermined for recovery when the system recovery operation is executed in this embodiment of the invention. If an operating system of another disk partition requires recovery, one more recovery keys can be set or a recovery menu is created using software simulation and the desired operating system is then manually selected.

Next, the recovery system decompresses the image file in the third disk partition and executes an operating system installation program (step S11). After the operating system is completely installed, the flag value is set as 0 (step S12), and computer system is then rebooted (step S13).

The invention backs up source installation programs of an operating system for a computer system, instead of an installed operating system, as an image file for recovery, which is not limited to backup and recovery on the same disk partition. Additionally, the invention has the advantages of excitability under a DOS environment, protecting business secrets without requiring any installation CD, execution of a recovery procedure without requiring other software, and version updates any time.

Although the present invention has been described in preferred embodiment, it is not intended to limit the invention thereto. Those skilled in this technology can still make various alterations and modifications without departing from the scope and spirit of this invention. Therefore, the scope of the present invention shall be defined and protected by the following claims and their equivalents.

What is claimed is:

1. A method for operating system recovery, applied to a computer system, comprising:
defining a flag and setting a quick key for the computer system;
the computer system providing a hard disk comprising at least one first disk partition and second disk partition, wherein the first disk partition comprises an operating system and the second disk partition comprises a recovery program and an image file corresponding to source installation programs of the operating system;
triggering the quick key for activating the operating system and setting a corresponding flag value accordingly;
loading the recovery program into a storage medium of the computer system according to the flag value;
executing the recovery program for creating a recovery system; and
the recovery system executing operating system installation using the image file for recovering the operating system of the computer system.

2. The method as claimed in claim 1, further comprising executing the recovery system for simulating a boot environment corresponding to the operating system.

3. The method as claimed in claim 2, further comprising resetting the flag value after the operating system of the computer system is recovered, and then rebooting the computer system.

4. The method as claimed in claim 3, wherein the storage medium is a random access memory or the hard disk.

5. A system for operating system recovery, applied to a computer system, comprising:
a storage medium;
a hard disk, comprising at least one first disk partition and one second disk partition, wherein the first disk partition comprises an operating system and the second disk partition comprises a recovery program and an image file corresponding to source installation programs of the operating system;
a recovery key, set to the computer system; and
a BIOS, loading the recovery program into the storage medium system according to a flag when the recovery key is triggered, executing the recovery program for creating a recovery system, and executing operating system installation using the image file based on the recovery system for recovering the operating system of the computer system.

6. The system as claimed in claim 5, wherein a corresponding flag value is set when the quick key for activating the operating system is triggered.

7. The system as claimed in claim 6, wherein the BIOS loads the recovery program into the storage medium according to the flag value.

8. The system as claimed in claim 7, wherein the flag value is reset after the operating system of the computer system is recovered, and the computer system is then rebooted.

9. The system as claimed in claim 5, wherein the BIOS simulates a boot environment corresponding to the operating system using the recovery system.

10. The system as claimed in claim 5, wherein the storage medium is a random access memory or the hard disk.

11. A system for operating system recovery, applied to a computer system, comprising:
a storage medium;
a hard disk, comprising at least one first disk partition, second disk partition, and third disk partition, wherein the first disk partition comprises a Windows operating system, the second disk partition comprises a Linux operating system, and at least one recovery program and an image file corresponding to source installation programs of the Windows or Linux operating system are stored in the first, second, or third disk partition;
a recovery key, set to the computer system; and
a BIOS, loading the recovery program into the storage medium system according to a flag when the recovery key is triggered, executing the recovery program for creating a recovery system, and executing operating system installation using the image file based on the recovery system for recovering the Windows or Linux operating system.

12. The system as claimed in claim 11, wherein the recovery program and the image file corresponding to the source installation programs of the Windows operating system are stored in the second or third disk partition.

13. The system as claimed in claim 11, wherein the recovery program and the image file corresponding to the source installation programs of the Linux operating system are stored in the first or third disk partition.

14. The system as claimed in claim 11, wherein a corresponding flag value is set when the quick key for activating the operating system is triggered.

15. The system as claimed in claim 14, wherein the BIOS loads the recovery program into the storage medium according to the flag value.

16. The system as claimed in claim 15, wherein the flag value is reset after the operating system of the computer system is recovered, and the computer system is then rebooted.

17. The system as claimed in claim 11, wherein the BIOS simulates a boot environment corresponding to the operating system using the recovery system.

18. The system as claimed in claim 11, wherein the storage medium is a random access memory or the hard disk.
